(19) United States
(12) Patent Application Publication
(10) Pub. No.: US 2001/0020420 A1
(43) Pub. Date: Sep. 13, 2001

(54) Roll assembly and roll

(76) Inventor: Heinz-Michael Zaoralek, Konigsbronn (DE)

Correspondence Address: Christopher R. Lewis, RATNER & PRESTIA, One Westlakes, Berwyn, Suite 301, P.O. Box 980, Valley Forge, PA, 19482-0980, US

(21) Appl. No.: 09/754,390

(22) Filed: Jan. 4, 2001

(30) Foreign Application Priority Data
Jan. 5, 2000 (DE) 100 00 231.5

(51) Int. Cl. B30B 3/04

(52) U.S. Cl. 100/169

(57) ABSTRACT

A roll assembly for pressure-treatment and preferably also for heat-treatment, of a web-type medium comprises at least two rolls, having roll bodies (3) forming a nip for the medium transported between the two rolls, bowing of the rolls possibly being partially compensated mechanically, such as by interlacing the rolls relative to each other (skewing) or bending the rolls by means of each having two bearings per trunnion (roll-bending). The radial local stiffness of at least one of the roll bodies (3) is varied axially such that the profile of the local stiffness compensates a pre-existing nip error which was not eliminated by the mechanical compensation.

A roll for pressure-treatment, and preferably also for heat-treatment, of a web-type medium comprising a roll body (3) having a center bore (4) is distinguished in that for compensating a nip error in a rolling procedure, the radial local stiffness of the roll body (3) is varied by a diameter (d) of the bore (4) differing in size axially or by support rings.

### BACKGROUND OF THE INVENTION

1. Technical Field

The invention relates to a roll assembly and a roll for treating a web-type medium, such as for pressure-treatment, and preferably also for heat-treatment, of a web-type medium.

Rolls with which pressure is exerted on a web-type medium bend, resulting in the nip in the middle of the roll being larger than at the rims of the roll and the line pressure there being less.

2. Description of Related Art

This problem is typically solved in modern roll assemblies by at least one of the rolls being configured as a so-called bow compensating roll, i.e. a roll having a full-length non-rotating axis, around which a tube rotates. In the direction of the nip, the tube is supported by a hydrostatic or hydrodynamic means on the axis, which absorbs the nip pressure, it thereby bowing under the load. The nip itself—as well as the line pressure—can be evenly set by correspondingly controlling the hydraulic pressure. However, this design of the bow compensating roll, the hydraulic unit and the pressure controller increase the expense involved in making such a roll assembly.

Before introduction of the bow compensating rolls described above, there was no lack of solutions for solving the problem of compensating the bow by purely mechanical means. Total compensation is achieved, for example, by providing at least one of the rolls cambered. In accordance with the bow lines, this roll is ground to a diameter reducing towards the ends of the roll. The disadvantage in this is that grinding in such a way is only suited to a specific line pressure magnitude. If another line pressure is required, e.g. due to a change in batch, the roll must be exchanged for another which is suitably cambered.

Diminishing this bowing problem is also achieved by the rolls consisting of a tubular body and an axis which, however, are fixedly connected to each other in the so-called quarter points and supported there. The bow curve of the tube then becomes W-shaped and the profile error less.

Mechanical adjusters are also known, with which bowing of the roll can be compensated with varying line pressures, so-called “roll bending” being one example of this. The two trunnions of the roll are elongated, and each receives, at its outer end, an additional bearing, by means of which a counter pressure can be applied. Via the lever arms to the main bearings, the roll body is “bent back” to a certain extent. However, this functions only with relatively short rolls. The high forces materializing necessitate production of these rolls with a solid core of steel or from composite casting materials, which greatly adds to the expense of such roll assemblies. Compensation of the nip error is not perfect.

Another mechanism is so-called “skewing”, interlacing one of the rolls relative to the other. The nip, thus formed, widens towards the rims of the rolls to thus compensate bowing of the rolls. However, since the bow line and the correction fail do not precisely match, a W-shaped nip error remains, which increases the higher the line pressure and the longer the web length. This restricts the application of skewing mechanisms to tissue calenders, which are operated with exceedingly low line pressures. Where they can be employed, a skewing mechanism represents a very cost-effective alternative to using bow compensation rolls.

### SUMMARY OF THE INVENTION

An objective of the invention is to diminish nip errors in rolls employed for pressure-treatment, and preferably also for heat-treatment, of web-type media.

In accordance with the invention, in the case of a roll having a roll body comprising an axial center bore, the local stiffness of the roll body in the radial direction, i.e. the radial stiffness, is varied such that, due to the radial stiffness being varied axially, a nip error is compensated, which would otherwise occur during rolling off of the roll against a backing roll, if the stiffness was not varied in accordance with the invention. In an advantageous embodiment, the roll comprises a rotationally-symmetrical, hollow-cylindrical roll body, the wall thickness of which, measured in the radial direction, changes axially. The wall thickness would be greater, the wider the nip width, without the wall thickness variation in accordance with the invention. The bore diameter or wall thickness is optimized so that practically a constant nip width is achieved over the length of the roll body acting on the medium.

The variation of the radial stiffness of the roll body is achievable by a supporting means, arranged in the roll body bore, i.e. in the cavity extending throughout the roll body. The supporting means can be achieved by one ring, or preferably several rings, arranged in the bore cavity. The ring, or preferably the several rings, are so dimensioned and arranged juxtaposed in axial direction, and form the bore in such an arrangement, such that the expected nip error is compensated. Advantageously, support structures, extending radially from the shell of the roll body to the rotary axis of the roll body, are not required. In the case of an arrangement of several rings, all the rings may be identically formed or may have different widths in axial direction of the roll body and/or have different strengths in radial direction, in order to optimally compensate the nip error to be expected during operation of the roll.

In a likewise preferred embodiment, variation of the radial stiffness is achieved directly by shaping the shell of a roll body. The invention provides a roll and roll assembly for the pressure-treatment and, where necessary, the heat-treatment, of web-type media, such as e.g. paper, which is cost-effective to produce. One substantial cost advantage results from compensating bowing, preferably by purely mechanical means, without the profile errors otherwise usual with such solutions.

The invention is also aimed at extending the limits of application of skewing means, e.g. to a so-called soft calender, which, in many cases, concerns an assembly of two rolls, one of which has a hard and heated surface, while the other has a comparatively soft coating of rubber or of a polymer plastics material. This coating has given calender its name.

Due to the soft coating, a wide working nip materializes in operation of soft calenders, which, in turn, necessitates a high line pressure to achieve the desired smoothing effect. Line pressures in the range of 100 to 250 N/mm are usual. Due to cost reasons, the rolls used are designed in accordance with the strength of the roll material. The permissible bending capacity is then so large that the remaining error in the nip profile for the smoothing operation can no longer be tolerated. Increasing the roll diameter to the necessary extent is not feasible, since this would make the rolls and the calender too heavy to handle. In addition, the automatically increased width of the working nip has disadvantageous effects on the smoothing operation itself.

For reasons pertaining to weight, the rolls of soft calenders are designed with large center bores. Due to mechanical relationships, the material removed by boring greatly affects the weight, but only unsubstantially affects the bending. Precise calculations have indicated, however, that the line pressure results in a deformation of the shell of the roll, which, in principle, can be described with a one-sided flattening. The value of this flattening depends, on the one hand, on the intensity of the line pressure, on the other, however, on the wall thickness of the roll body. These are directly influenced by varying the diameter of the center bore.

In accordance with the invention, this effect is employed to compensate the remaining W-shaped errors in the nip profile, which occur upon skewing of the roll. For this purpose, one or also both rolls is/are provided in the soft calender with center bores, axially adapted in diameter to the anticipated nip error in the respective position, such that, given a constant line pressure, they give way radially by the amount of nip error. It can be demonstrated that both the amplitude of the nip error remaining after skewing and the amount of the elastic radial deformation behave proportional to the line pressure in each case. Thus, when the center bore has been correctly shaped by skewing adapted to the line pressure, a constant nip pressure results, which requires no further correction.

### BRIEF DESCRIPTION OF THE DRAWINGS

A preferred embodiment of the invention will now be detailed with reference to the drawings. All the features disclosed by way of the example embodiment, each advantageously form singly or in any combination, further developments of the claimed invention. In the drawings:

FIG. 1 is a plot of the nip error profile,

FIG. 2A is a schematic cross-section through a roll in accordance with a first embodiment of the invention,

FIG. 2B is a schematic cross-section through a roll in accordance with a second embodiment of the invention, and

FIG. 3 is a plot showing the maximum flattening of the roll as shown in FIG. 2, and the maximally-occurring nip error upon skewing of a conventional roll, each as a function of the line pressure skewing adapted to the line pressure.

### DETAILED DESCRIPTION OF THE PREFERRED EMBODIMENTS

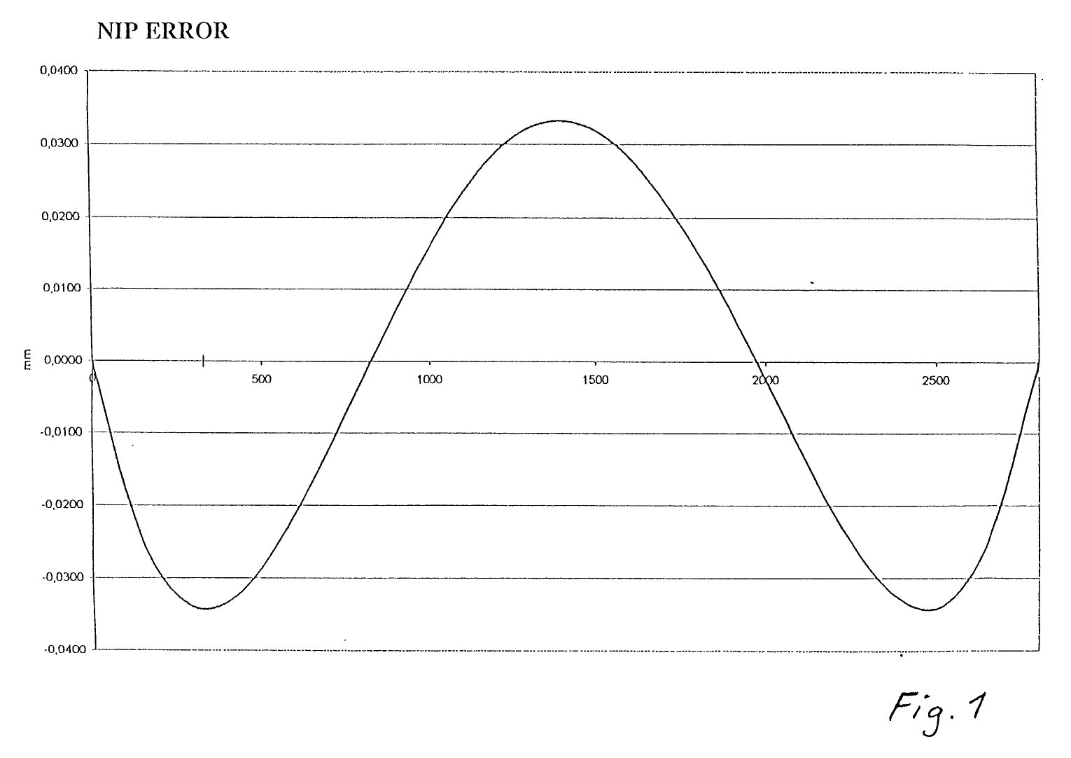

Illustrated in FIG. 1, by way of example, is a plot of the nip error in a soft calender over the width of a web-type medium, in this case over the width of the paper web, as materializing for a line pressure of 250 N/mm and optimized interlacing. Both rolls forming the nip have an outer diameter of 610 mm and a bearing center-spacing of 3,600 mm. One of the roll bodies is produced of clear chill casting, the other of gray cast iron. The width of the paper web illustrated is 2,800 mm. The amplitude of the nip error is approx. +−34 μm, which is no longer acceptable for a soft calender. As used herein, a “pre-existing nip error” shall mean a nip error profile which exists in a roll assembly prior to being modified according to the present invention, including the nip error existing with no attempt to compensate for the error or after some attempt to compensate has been done, such as skewing or roll-bending.

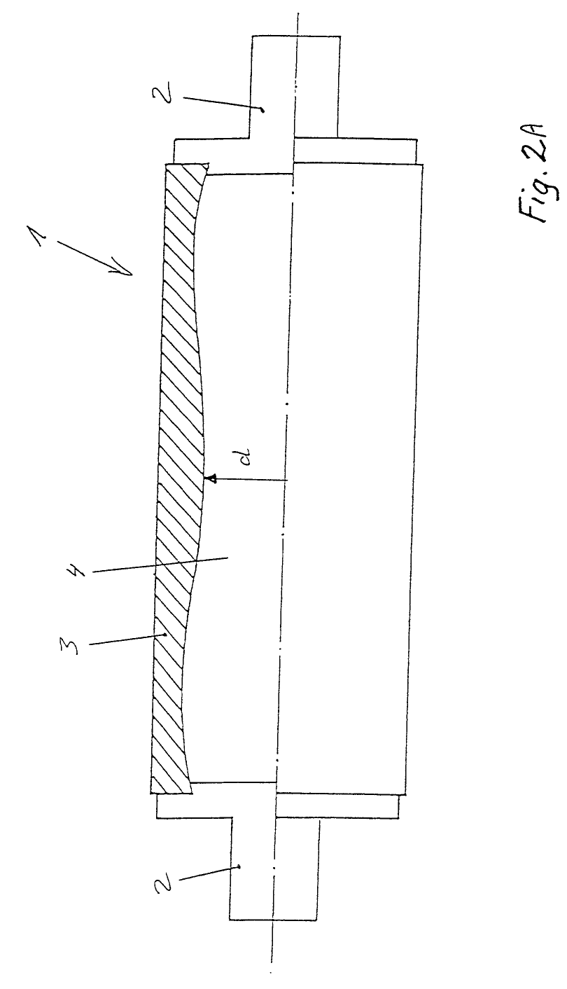

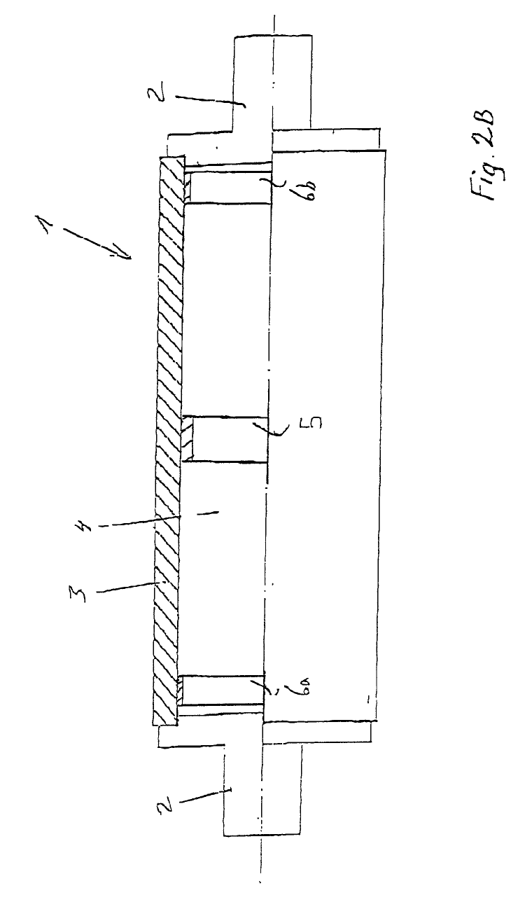

FIG. 2A illustrates the roll 1 of gray cast iron having an optimized wall thickness. To enable better representation, the illustration is scaled axially 1:20 and radially 1:10.

The roll 1 comprises, between its bearing trunnions 2, a rotationally-symmetrical, hollow-cylindrical roll body 3, which together with a roll body of a mating roll, forms the nip for the web transported therethrough. The roll body 3 comprises a center bore 4, having a bore diameter d. The bore diameter d varies along the axis of the roll. The size of the bore diameter d or the wall thickness of the roll body 3 is selected as a function of the nip error in the profile of FIG. 1, which is to be expected without the compensation in accordance with the invention, so that a nip of a width as constant as possible is attained.

The concentric, axial bore through the roll body enlarges gradually from the two roll body ends to a location of largest diameter d. The diameter d of the roll diminishes, again gradually, from the two locations of largest diameter to the axial center of the roll body, where the bore has the smallest diameter d. In this way, by reversing the W-shaped profile of the nip error to be expected in accordance with FIG. 1, an M-shaped profile, soft in axial direction, arises at the inner side of the roll body shell, having a maximum wall strength in the axial center of the roll body and two minima of the wall strength, lying symmetrical to both sides of the center.

Roughly 350 mm away from the rims of the roll—i.e. where the nip would be around 34 mm too small, because of the twisting—the wall of the roll is designed particularly thin and pliant. In the middle of the roll, relations are reversed. Calculations of the deformation of the roll body 3 show that for a variation of the bore diameter d between 460 mm at the two sides and 380 mm in the middle of the roll for a line pressure of 250 N/mm, makes for a difference in the deformation radially of approx. 70 μm, so that given such dimensioning of the bore 4 or of the wall thickness of the roll body 3, the anticipated nip error in accordance with FIG. 1 is just compensated.

FIG. 2B illustrates a roll according to a second embodiment of the invention, with the same reference numerals referring to the same elements as in FIG. 2A. The embodiment shown in FIG. 2A creates a variation in radial stiffness by a supporting device, such as rings 5 and 6a and 6b. As shown in FIG. 2B, ring 5 has a slightly greater width than rings 6a and 6b to compensate for a greater nip error in the middle of roll body 3. Although FIG. 2B illustrates three rings, any suitable design of rings and any number of rings, including only one ring, may be used depending on the nip error profile. In addition, one of the rings may have a different radial stiffness from other rings, as needed. The rings are fitted within the bore by known press fitting or shrink fitting techniques. For example, shrink fitting of the rings may be achieved by thermal treatment, which involves cooling the rings to shrink them for mounting and then letting them expand upon reaching the temperature of the roll after having been mounted in the roll bore. The rings may also be radially compressed to reduce their diameters then allowed to expand against the roll body after assembly.

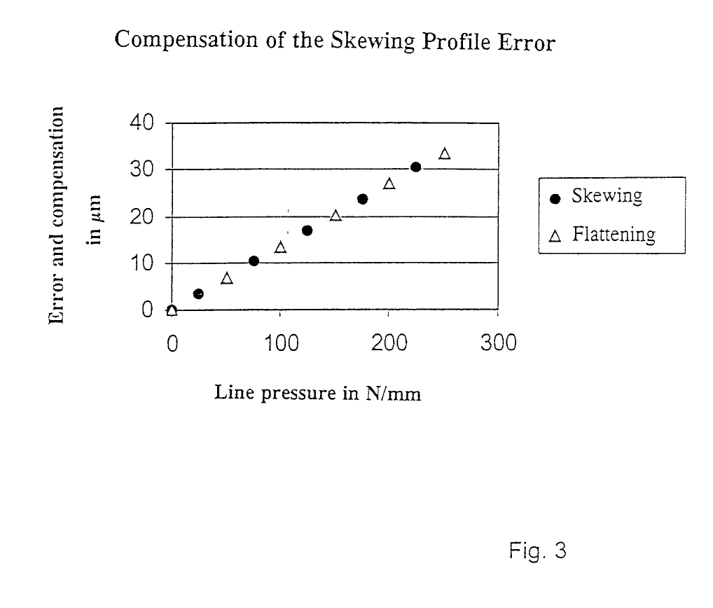

FIG. 3 illustrates both deformations as a function of the line pressure. It becomes clear that both neatly cancel each other out irrespective of the line pressure.

In principally the same way, nip errors can also be eliminated in other mechanical adjusting means, such as e.g. roll bending, and, in general, also for a non-shaped bow curve of the roll without compensation in accordance with the invention.

In the foregoing description, preferred embodiments of the invention have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed:

1. A roll assembly for pressure-treatment, and preferably also for heattreatment, of a web-type medium comprising
a) at least two rolls, having roll bodies forming a nip for the medium transported between the two rolls,
b) bowing of the rolls being compensated by a mechanically acting means of compensation, like interlacing the rolls relative to each other (skewing) or bending the rolls by means of each having two bearings per trunnion (roll-bending), wherein
c) the radial local stiffness of at least one of the roll bodies is varied axially such that the profile of the local stiffness compensates a nip error which was not eliminated by said compensation means.

2. The roll assembly as set forth in claim 1, wherein the roll body comprises a center bore having diameters differing in size in axial direction.

3. The roll assembly as set forth in claim 1, wherein said roll assembly consists of at least three rolls, and at least the roll body of the middle of the three rolls is provided with said varied local stiffness in radial direction.

4. The roll assembly as set forth in claim 1, wherein each of the roll bodies of two or more nip-forming rolls comprises a radial local stiffness varied axially.

5. A roll for pressure-treatment, and preferably also for heat-treatment, of a web-type medium comprising a roll body having a center bore, wherein for compensating a nip error in a rolling procedure, the radial local stiffness of the roll body is varied by a diameter (d) of the bore differing in size axially.

6. The roll as set forth in claim 5, wherein said radial local stiffness of the roll body is produced by an inner support means, arranged in the bore.

7. The roll as set forth in claim 6, wherein the inner support means is formed by at least one ring, arranged in the bore.

8. The roll as set forth in claim 7, wherein the ring is fitted in the bore by at least one of shrink fitting or press fitting the ring in the bore.

9. The roll as set forth in claim 6, wherein the inner support means is formed by several rings.

10. The roll as set forth in claim 9, wherein at least one of the rings comprises a radial stiffness different to that of one other ring or several other rings.

11. A roll assembly for treating a web-type medium comprising at least two rolls having roll bodies forming a nip between the two rolls through which the medium is transported, wherein at least one of the roll bodies has a radial local stiffness which is varied axially such that the profile of the local stiffness compensates a pre-existing nip error.

12. The roll assembly as set forth in claim 11, wherein the roll body comprises a center bore having diameters differing in size in the axial direction.

13. The roll assembly as set forth in claim 11, wherein the roll assembly consists of at least three rolls, and at least the roll body of the middle of the three rolls is provided with the varied local stiffness in the axial direction.

14. The roll assembly as set forth in claim 11, wherein each of the roll bodies of two or more rolls has a radial local stiffness varied axially.

15. A roll for treating a web-type medium comprising a roll body having a center bore for compensating a pre-existing nip error in a rolling procedure, the radial local stiffness of the roll body is varied axially such that the profile of the local stiffness compensates and corresponds to the pre-existing nip error.

16. The roll as set forth in claim 15, wherein the radial local stiffness of the roll body is varied axially by an inner support means arranged in the bore.

17. The roll as set forth in claim 16, wherein the inner support means comprises at least one ring arranged in the bore.

18. The roll as set forth in claim 17, wherein the ring is fitted in the bore by at least one of shrink fitting or press fitting the ring in the bore.

19. The roll as set forth in claim 16, wherein the inner support means comprises a plurality of rings.

20. The roll as set forth in claim 19, wherein a first of the rings has a raldial stiffness different from that of at least one other ring.

21. The roll as set forth in claim 15, wherein the radial local stiffness of the roll body is varied axially by axially varying the diameter of the center bore.
